(19) United States
(12) Patent Application Publication
(10) Pub. No.: US 2008/0148971 A1
(43) Pub. Date: Jun. 26, 2008

(54) PRINTING DEVICE AND METHOD OF PATTERNING THIN FILM USING THE SAME

(76) Inventors: Chul Ho Kim, Paju-si (KR); Jung Jae Lee, Gwacheon-si (KR); Tae Young Oh, Paju-si (KR); Choon Ho Park, Anyang-si (KR)

Correspondence Address: BRINKS HOFER GILSON & LIONE, P.O. BOX 10395, CHICAGO, IL, 60610, US

(21) Appl. No.: 11/957,035

(22) Filed: Dec. 14, 2007

(30) Foreign Application Priority Data
Dec. 20, 2006 (KR) 10-2006-013075

(51) Int. Cl. B41F 5/00

(52) U.S. Cl. 101/216; 101/483

(57) ABSTRACT

A printing device can be fabricated in a large size, and a method of patterning a thin film using the same are disclosed. The printing device includes a printing roller that rolls on a substrate to form a thin film thereon. A plurality of blankets are adhered to the printing roller and coated with an organic liquid for the thin film.

### RELATED APPLICATIONS

This application claims the benefit of Korean Patent Application No. 2006-130753 filed on Dec. 20, 2006, which is hereby incorporated by reference.

### BACKGROUND

1. Technical Field

The present disclosure relates to a printing device and a method of patterning a thin film using the same, and more particularly, to a printing device which can be fabricated in a large size, and a method of patterning a thin film using the same.

2. Discussion of the Related Art

Recently, various flat display devices have been developed to overcome disadvantageous properties of the large weight and size of Cathode Ray Tubes (CRTs). For example, various flat display devices include a liquid crystal display (LCD) device, a field emission display (FED), a plasma display panel (PDP), and an electro-luminescence (EL) display device.

A flat display device includes a plurality of thin films which are formed by mask steps inclusive of deposition (coating), exposure, development and etching. However, the mask steps may cause the complicated process and increasing fabrication cost. In this respect, there are increasing studies for a method to form a thin film by a printing process using a printing roller.

The printing process includes forming a predetermined pattern on a printing roller by using a printing plate, and transferring the predetermined pattern to a substrate so as to form a thin film thereon.

For the printing process, as shown in FIG. 1, a blanket 30 having a recess part 22 and a partition 24 is adhered to a printing roller 10. Each of the blanket 30 and the printing roller 10 is provided in the same size as the substrate on which the thin film is formed.

Accordingly, as the substrate is increased in size, it is necessary to increase the printing roller 10 and blanket 30 in size. With the increase in size of the blanket 30, the blanket 30 sags due to its weight, thus creating a limitation on the increase of size in the blanket.

### SUMMARY OF THE DISCLOSURE

Accordingly, the present disclosure is directed to a printing device and a method of patterning a thin film using the same that substantially obviates one or more problems due to limitations and disadvantages of the related art.

Additional advantages, objects, and features of the disclosure will be set forth in part in the description which follows and in part will become apparent to those having ordinary skill in the art upon examination of the following or may be learned from practice of the disclosure.

In one aspect, a printing device is disclosed that includes a printing roller, which rolls on a substrate to form a thin film thereon, and a plurality of blankets adhered to the printing roller and coated with an organic liquid for the thin film.

In another aspect, a method is disclosed for patterning a thin film including preparing a printing roller having a plurality of blankets being adhered to the outer surface thereof, coating the blankets with an organic liquid; forming an organic pattern by rolling the printing roller coated with the organic liquid on a printing plate; transferring the organic pattern of the printing plate to a substrate; and curing the organic pattern on the substrate.

It is to be understood that both the foregoing general description and the following detailed description of the present disclosure are exemplary and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principles of the disclosure. Following is a brief description of the drawings.

FIG. 1 is a perspective view of illustrating a blanket adhered to a printing roller according to the related art.

FIG. 2 is a perspective view of illustrating a printing device according to the present disclosure.

FIG. 3 is a perspective view of illustrating a blanket adhered to a printing roller as shown in FIG. 2.

FIGS. 4A to 4C are perspective views of illustrating various embodiments of a blanket as shown in FIG. 3, showing the blanket in a flattened state.

FIGS. 5A to 5D are perspective views of illustrating a mother substrate corresponding to the blanket shown in FIG. 3.

FIGS. 6A to 6C are cross section views of illustrating a method of forming a thin film using a printing device according to the present disclosure.

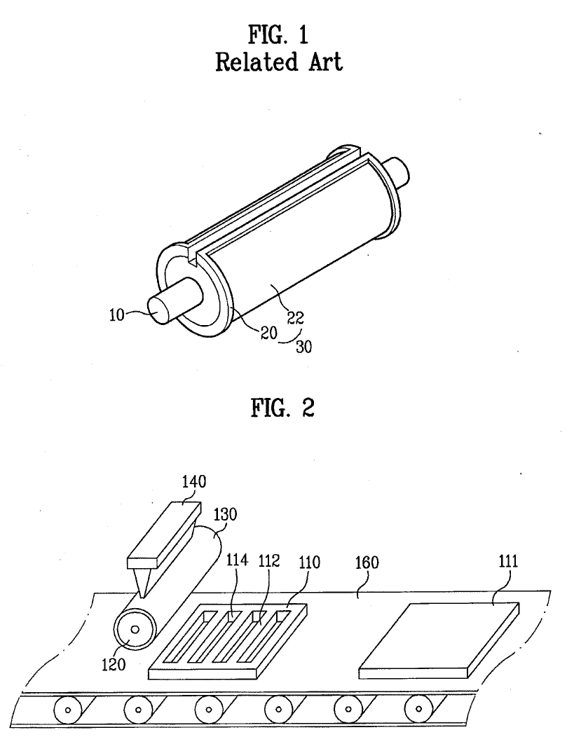

### DETAILED DESCRIPTION

Reference will now be made in detail to the specific embodiments of the present disclosure, examples of which are illustrated in the accompanying drawings. Wherever possible, the same reference numbers will be used throughout the drawings to refer to the same or like parts.

Hereinafter, a printing device according to the present disclosure and a method of patterning a thin film using the same will be described with reference to the accompanying drawings.

FIG. 2 is a perspective view of illustrating a printing device to pattern a thin film according to the present disclosure. The printing device includes an organic liquid supplier 140, a printing roller 120, a blanket 130, and a printing plate 110. The organic liquid supplier 140 stores an organic liquid therein, and supplies the stored organic liquid to a surface of the blanket 130 of the printing roller 120.

The printing plate 110 is brought into contact with the printing roller 120 so that the organic liquid coated on the blanket 130 of the printing roller 120 remains only on predetermined portions thereof. For this, the printing plate 110 is provided with recess patterns 114 and protruding patterns 112. If the printing roller 120 rolls along on the printing plate 110, the protruding patterns 112 are brought into contact with the organic liquid coated on the printing roller 120. Accordingly, if the printing roller 120 rolls along on the printing plate 110, the organic liquid of the printing roller 120 is transferred to the protruding patterns 112 of the printing plate 110.

When the printing roller 120 rolls along on the printing plate 110, the recess patterns 114 are not brought into contact with the organic liquid of the printing roller 120. Thus, the organic liquid of the printing roller 120 corresponding to the recess patterns 114 is formed as an organic pattern remaining on the printing roller 120.

The blanket 130 adhered to the outer surface of the printing roller 120 is coated with the organic liquid supplied from the organic liquid supplier 140. The printing roller 120 rolls along on the printing plate 110 and the substrate 111, which are sequentially moved by a transfer 160 so that the printing roller 120 is brought into contact with the printing plate 110 and the substrate 111 in sequence. In another way, the printing roller 120 may be moved to be in contact with the printing plate 110 and the substrate 111 sequentially.

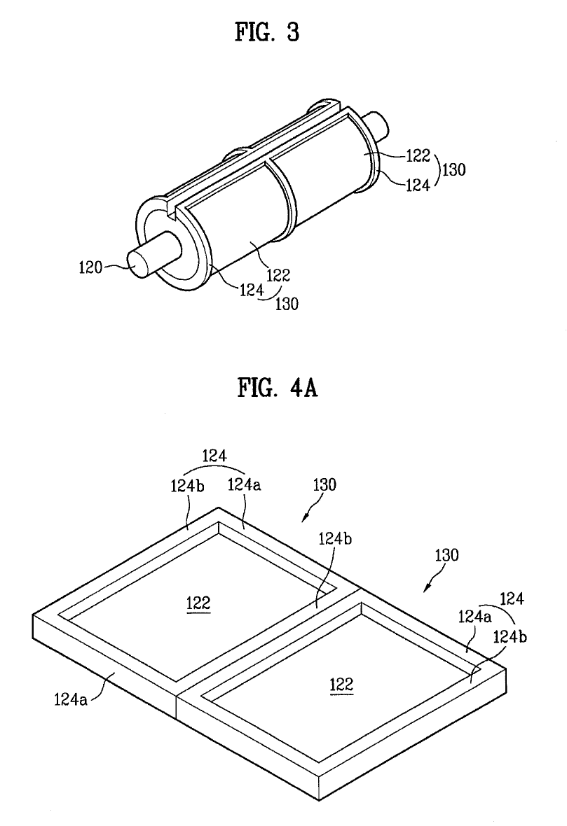

As shown in FIG. 3, at least two rubber blankets 130 are adhered to the printing roller 120 that in turn may be applied to a large-sized substrate. Each of the two rubber blankets 130 include a recess part 122 and a plurality of partitions 124 that define the recess part 122.

The recess part 122 is formed so as to allow the organic liquid from the organic liquid supplier 140 to be filled therein.

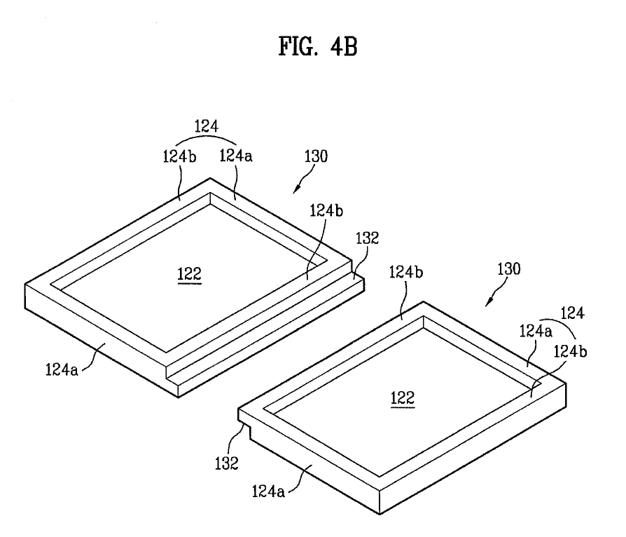

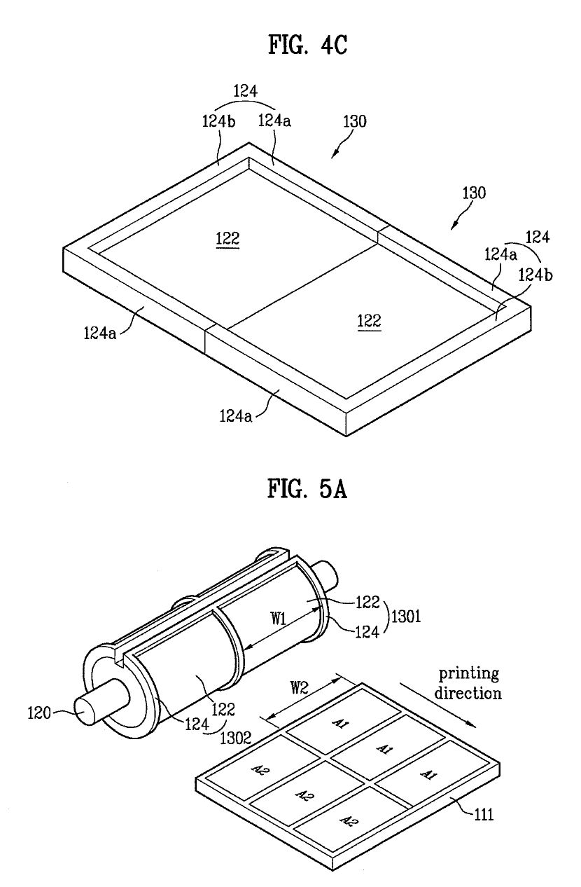

The plurality of partitions 124 surround the recess parts 122 so as to provide a space filled with the organic liquid. As shown in FIGS. 4A to 4C, the partitions 124 include the first partitions 124a formed in parallel, and the second partitions 124b respectively connected with the first partitions 124a.

The second partitions 124b shown in FIG. 4A are adhered to the printing roller 120 such that the second partitions 124b of one recess part 122 are opposite to the other second partitions 124b of the adjacent recess part 122. Accordingly, the printing roller 120 provided with the plurality of recess parts 122 can be applicable to a large-sized substrate.

The second partitions 124b shown in FIG. 4B are provided with stepped or inclined connection parts 132. The connection parts 132 of the adjacent blankets 130 adhered to the same printing roller 120 are provided as symmetrical shapes to be coupled to each other. The total thickness of the coupled connection parts 132 is substantially identical to the thickness of the first partition 124a. Owing to the connection parts 132, the relative contact area between the second partitions 124b of the adjacent blankets 130 is increased, thereby strengthening the fixation between the blankets 130 adhered to the same printing roller 120.

In order to form open-shaped recess parts 122 in at least two second blankets 130 adhered to the same printing roller 120, as shown in FIG. 4C, the second partition 124b is connected with each end of the first partitions 124a. That is, the second partitions 124b are formed only in the circumference of the printing roller 120. In this case, at least two blankets 130 are adhered to the printing roller 120 such that the respective recess parts 122 included in at least two blankets 130 are connected to each other. Accordingly, the entire size of the recess part 122 shown in FIG. 4C is larger than the entire size of the recess part 122 divided by the second partitions 124b shown in each of FIGS. 4B and 4C.

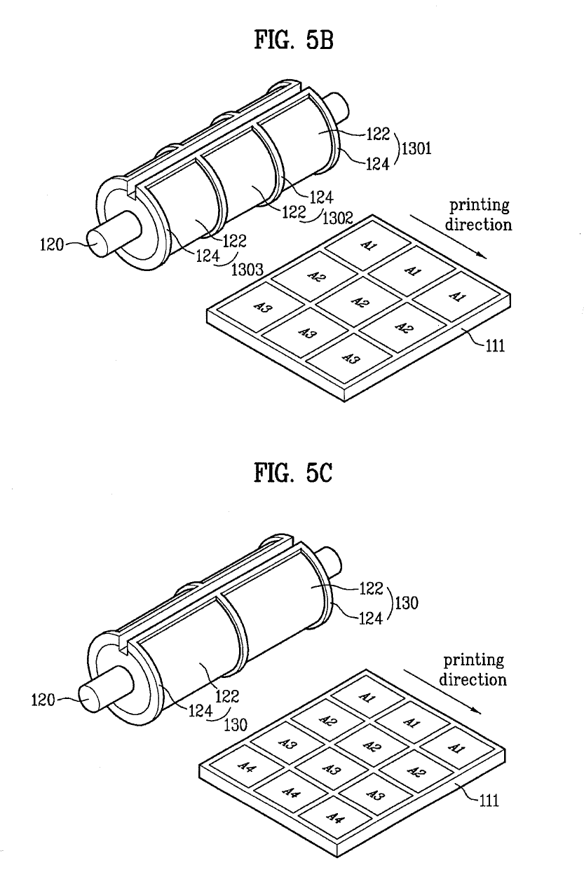

FIGS. 5A to 5D illustrate a printing device using the blanket according to the present disclosure, and a substrate including a thin film formed by the printing device.

As shown in FIG. 5A, a printing roller 120 provided with first and second blankets 1301 and 1302 being adhered thereto rolls along on a mother substrate 111 including first and second active regions A1 and A2 arranged in a column or in a row direction such that corresponding thin films are formed on the mother substrate 111. Accordingly, the first and second blankets 1301 and 1302 are respectively provided in correspondence with the first and second active regions A1 and A2 arranged in the column direction. More particularly, the first blanket 1301 corresponds to the first active region A1, and the second blanket 1302 corresponds to the second active region A2. Meanwhile, after forming the thin film, the first and second active regions A1 and A2 are divided by scribing, thereby completing a plurality of display devices.

As shown in FIG. 5B, a printing roller 120 provided with first, second, and third blankets 1301, 1302, and 1303 being adhered thereto rolls on a mother substrate 111 to create first, second, and third active regions A1, A2, and A3 arranged in a column or row direction such that corresponding thin films are formed on the mother substrate 111. Accordingly, the first to third blankets 1301 to 1303 are respectively provided in correspondence with the first to third active regions A1 to A3 arranged in the column direction. More particularly, the first blanket 1301 corresponds to the first active region A1, the second blanket 1302 corresponds to the second active region A2, and the third blanket 1303 corresponds to the third active region A3.

As shown in FIG. 5C, a printing roller 120 provided with first and second blankets 1301 and 1302 being adhered thereto rolls on a mother substrate 111 including first, second, third, and fourth active regions A1, A2, A3, and A4 arranged in a column or row direction such that thin films are formed on the mother substrate 111. Accordingly, each of the first and second blankets 1301 and 1302 corresponds to the active regions divided by the unit of two columns. More particularly, the first blanket 1301 corresponds to the first and second active regions A1 and A2, and the second blanket 1302 corresponds to the third and fourth active regions A3 and A4.

As shown in FIG. 5D, a printing roller 120 provided with first and second blankets 130a and 1302 being adhered thereto rolls on a mother substrate 111 including active regions B1, B2, C1, C2, C3, and C4 that are divided into at least two groups with different sizes such that thin films are formed on the mother substrate 111. Accordingly, the first blanket 1301 corresponds to the first active region B1 having the first size and the first and second active regions C1 and C2, each having the second size, arranged in the same column or row direction as the first active region B1 having the first size. Also, the second blanket 1302 corresponds to the second active region B2 having the first size and the third and fourth active regions C3 and C4, each having the second size, arranged in the same column or row direction as the second active region B2 having the first size.

As shown in FIG. 5A, the width (W1) of the recess part is larger than the width (W2) of each active region formed on the mother substrate 111. Also, the partition 124 of the blanket 130 corresponds to a non-active region between the active regions on the mother substrate 111. Also, the number of blankets 130 adhered to the printing roller 120 may be varied based on the size of the mother substrate 111 and the number and size of the active regions formed on the mother substrate 111. The position, size, and shape of the blanket 130 are determined based on the arrangement of the active regions formed on the mother substrate 111.

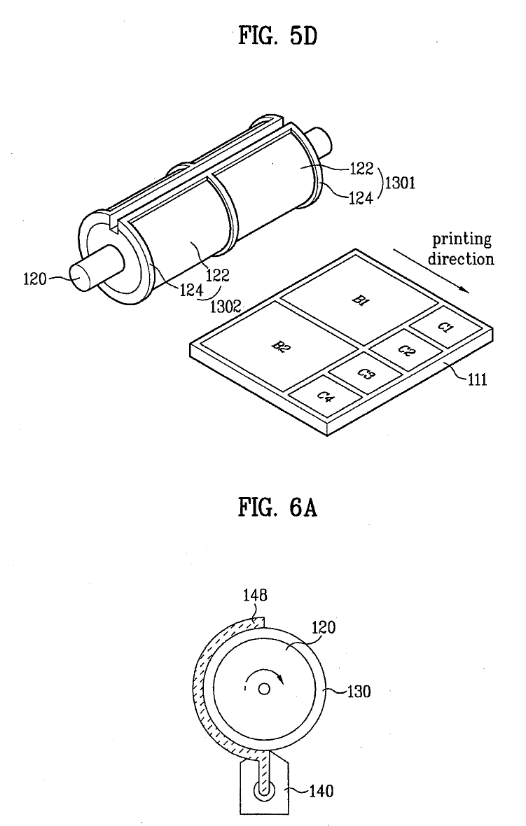

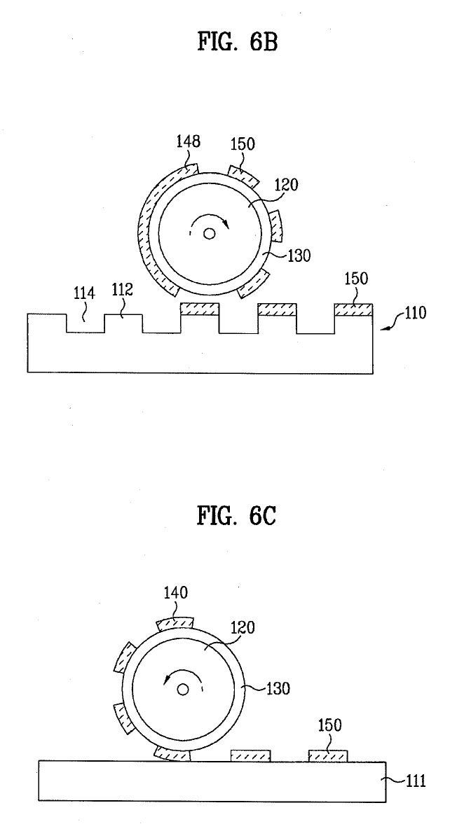

FIGS. 6A to 6C are cross section views of illustrating a method to pattern a thin film using a printing device according to the present disclosure.

As shown in FIG. 6A, the printing roller 120 having the blanket 130 adhered thereto is prepared by coating the blanket 130 with an organic liquid 148 supplied through the organic liquid supplier 140.

Then, as shown in FIG. 6B, the printing roller 120 coated with the organic liquid 148 rolls on a printing plate 110 including recess 114 and protruding patterns 112. Accordingly, the organic liquid 148 provided on the portions corresponding to the protruding patterns 112 is transferred thereto as the organic liquid 148 is brought into contact with the protruding patterns 112. Meanwhile, the organic liquid 148 provided on the portions corresponding to the recess patterns 114 remains on the surface of the blanket 130, thereby forming an organic pattern 150.

The printing roller 120 provided with the organic pattern 150 rolls on the substrate 111 as shown in FIG. 6C. Accordingly, the organic pattern 150 is transferred to the substrate 111, and the transferred organic pattern 140 is dried and cured, thereby forming an organic thin film.

Meanwhile, the printing device according to the present disclosure may form color filter and black matrix included in a liquid crystal display (LCD) device, and an organic thin film included in an organic light-emitting diode (OLED) display device.

As mentioned above, the printing device according to the present disclosure and the method of patterning the thin film using the same have the following advantages.

Because the plurality of blankets are adhered to each printing roller, the plurality of blankets may be provided without regard to the large-sized printing roller. Also, the printing device according to the present disclosure and the patterning method using the same can be applicable to the large-sized substrate according as the plurality of blankets are adhered to each printing roller, thereby preventing lowering of yield caused by the inferiority when fabricating the large-sized blanket.

It will be apparent to those skilled in the art that various modifications and variations can be made in the present disclosure without departing from the spirit or scope of the disclosures. Thus, it is intended that the present disclosure covers the modifications and variations of this disclosure provided they come within the scope of the appended claims and their equivalents.

What is claimed is:

1. A printing device comprising:
a printing roller, which rolls on a substrate to form a thin film on the substrate; and
a plurality of blankets adhered to the printing roller and coated with an organic liquid for the thin film.

2. The printing device of claim 1, wherein each of the plurality of blankets comprises:
a recess part to be filled with the organic liquid; and
a plurality of partitions to define the recess part.

3. The printing device of claim 2, wherein a plurality of active regions having the same size are formed on the substrate.

4. The printing device of claim 3, wherein the plurality of blankets adhered to the printing roller respectively correspond to the plurality of active regions arranged by a unit of at least one column or at least one row.

5. The printing device of claim 3, wherein the position, size, and shape of the plurality of blankets are determined based on the arrangement of active regions to be formed on the substrate.

6. The printing device of claim 3, wherein the width of the recess part is larger than the width of each active region.

7. The printing device of claim 2, wherein a plurality of active regions, divided into at least two groups having different sizes, are formed on the substrate.

8. The printing device of claim 7, wherein the position, size, and shape of the plurality of blankets are determined based on an arrangement of active regions to be formed on the substrate.

9. The printing device of claim 7, wherein the plurality of blankets adhered to the printing roller respectively correspond to the plurality of active regions arranged by a unit of at least one column or at least one row.

10. The printing device of claim 7, wherein the width of each recess part is larger than the width of each corresponding active region of different size.

11. The printing device of claim 2, wherein the plurality of partitions comprise:
first partitions formed in parallel; and
second partitions connected with the first partitions.

12. The printing device of claim 11, wherein the second partitions are provided with stepped or inclined connection parts to connect at least two of the plurality of blankets.

13. The printing device of claim 11, wherein the second partitions are disposed in the circumference of the printing roller so as to connect the recess parts of at least two of the plurality of blankets to each other.

14. A method of patterning a thin film comprising:
adhering a plurality of blankets to an outer surface of a printing roller;
coating the blankets with an organic liquid;
forming an organic pattern on the plurality of blankets by rolling the printing roller on a printing plate that includes a predetermined pattern for the organic pattern;
Rolling the printing roller to transfer the organic pattern of the printing plate to a substrate; and
curing the organic pattern on the substrate.

15. The method of claim 14, further comprising:
defining in each blanket a recess part to be filled with the organic liquid and a plurality of partitions to define the recess part.

16. The method of claim 15, wherein a plurality of active regions having the same size are formed on the substrate.

17. The method of claim 16, wherein the position, size, and shape of the plurality of blankets are determined based on an arrangement of the plurality of active regions to be formed on the substrate.

18. The method of claim 16, wherein the plurality of blankets adhered to the printing roller respectively correspond to the plurality of active regions arranged by a unit of at least one column or at least one row.

19. The method of claim 16, wherein the width of the recess part is larger than the width of each active region.

20. The method of claim 15, wherein a plurality of active regions, divided into at least two groups having the different sizes, are formed on the substrate.

21. The method of claim 20, wherein the position, size, and shape of the plurality of blankets are determined based on the arrangement of active regions to be formed on the substrate.

22. The method of claim 20, wherein the plurality of blankets adhered to the printing roller respectively correspond to the plurality of active regions arranged by a unit of at least one column or at least one row.

23. The method of claim 20, wherein the width of the recess part is larger than the width of each active region.

24. A printing device comprising:
a printing roller that rolls on a substrate to form a thin film thereon; and
a plurality of blankets adhered to the printing roller, each including a plurality of partitions that define a plurality of recesses for reception of an organic liquid in a pattern corresponding to the thin film to be formed.

25. The printing device of claim 24, wherein each of the plurality of recesses corresponds to at least two active regions that include at least two different sizes thereof.
